(19) United States
(12) Patent Application Publication
(10) Pub. No.: US 2011/0069833 A1
(43) Pub. Date: Mar. 24, 2011

(54) EFFICIENT NEAR-DUPLICATE DATA IDENTIFICATION AND ORDERING VIA ATTRIBUTE WEIGHTING AND LEARNING

(75) Inventors: Serge Volkoff, San Bruno, CA (US); Darryl Lovato, Royal Oaks, CA (US); Vladimir V. Semenyuk, Stockholm (SE)

(73) Assignee: SMITH MICRO SOFTWARE, INC., Aliso Viejo, CA (US)

(21) Appl. No.: 12/559,315

(22) Filed: Sep. 14, 2009

Related U.S. Application Data
(63) Continuation-in-part of application No. 12/329,480, filed on Dec. 5, 2008.
Application No. 12/329,480 is a continuation-in-part of application No. 12/208,296, filed on Sep. 10, 2008.
(60) Provisional application No. 60/971,739, filed on Sep. 12, 2007.

(51) Int. Cl. H04L 9/28; H04L 9/00; H04K 1/00; G06F 7/00; G06F 17/00

(52) U.S. Cl. 380/28; 707/699

(57) ABSTRACT

A method to efficiently detect, and thus store, approximately duplicate or most likely duplicate files or data sets that will benefit from differencing technology rather than standard compression technology. During archive creation or modification, sets of most likely files are detected and a reduced number of transformed file segments are stored in whole. During archive expansion, one or more files are recreated from each full or partial copy.

### CROSS REFERENCES TO RELATED APPLICATIONS

The present application is a continuation-in-part of each of U.S. Utility patent application Ser. No. 12/208,296, filed Sep. 10, 2008 (Sep. 10, 2008), entitled EFFICIENT FULL OR PARTIAL DUPLICATE FORK DETECTION AND ARCHIVING; and U.S. Utility patent application Ser. No. 12/329,480, filed Dec. 5, 2008 (Dec. 5, 2008), entitled PREDICTION WEIGHTING METHOD BASED ON PREDICTION CONTEXTS, each of which application is incorporated in its entirety by reference herein.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Field of the Invention

The present invention relates generally to data filtering and archiving. More particularly the present invention relates to a system and method for efficiently detecting and storing multiple files that contain similar or approximately duplicates of each other data based on their attributes. More specifically, the method relates to a system of detecting the most likely similar data pairs out of an original group of input data. In an archiving system, these similar pairs can be exploited by using delta encoding (differences between files) rather than compressing each file of the pair individually.

2. Discussion of Related Art Including Information Disclosed Under 37 CFR §§1.97, 1.98

Archiving software such as STUFFIT®, ZIP®, RAR®, and similar utilities, enable users to combine or package multiple files into a single archive for distribution. At the same time, these products enable users to compress and encrypt the files so that bandwidth costs and storage requirements are minimized when sending the resulting archive across a communication channel or when storing it in a storage medium.

Files added to an archive are frequently approximate duplicates of other files already archived or are very similar based on their respective attributes. Current archiving software, such as the utilities mentioned above, compress each data set as a whole, without detecting duplicate sets and therefore without being able to use differencing technology rather than “compression” on approximately duplicate or most likely similar data sets (i.e., most likely duplicate files). It would be advantageous, therefore, to detect when a subset of data set being added to an archive is nearly identical on the basis of having the same or similar actual data, and instead of compressing and storing additional copies of the file data, simply storing a reference to the compressed data already present in the first archived copy of the file. Moreover, it is desirable that the detection and coding of the identical files be as time efficient as possible.

Using a brute force method of comparing an input set of files for those files that have the greatest benefit (smallest size) from using a differencing method rather than a standard compression method is far too costly in terms of processing speed, temporary storage, and memory requirements—mathematically, the brute force method would require nearly O(n̂2) differences to be actually attempted, and then use the smallest result out of the various combinations.

Current products, such as backup software, use diffing technology to archive files smaller than files produced by compression of the individual file, but if the diffing algorithm bases the files it compares/differences based on the file locations in the file system (i.e. Backup software), it has a much better hint as to what are possible matches.

### BRIEF SUMMARY OF THE INVENTION

In contrast with prior art systems and products, the present invention narrows N number of randomly selected files to be compressed into an archive to a small subset of possible matched pairs, thereby reducing the large number of potential file pairs down to the most likely to benefit from using a differencing technique. It takes this approach rather than any of the well known compression techniques, including Huffman, Arithmetic Coding, Lempel Ziv variants, as well as others.

Accordingly, the present invention provides a system and method that efficiently detects approximately duplicate files; then, rather than compress the second and subsequent occurrences of the duplicate data, the inventive method simply stores differences in a reference to the first compressed copy of the data. This process effectively compresses multiple copies of data by nearly 100% (only small amounts of reference information is stored), without repeated compression of the matching data.

Further, unlike the “block” or “solid” mode currently used by state of the art archiving products, the presently inventive method is not in any way dependent on the size of the files, compression history, or window size.

It must also be emphasized that while decompressing/extracting archived files, the present inventive method of storing references to the original data requires the extraction process to only use decompression, such as Lempel Ziv, Huffman, etc., of only the first occurrence of duplicate data; subsequent duplicates are processed during extraction by applying differences to the first set of data after it has been processed. As matching files are encountered, this method simply copies the already decompressed first occurrence data portions if there was an exact match, or applies the differencing instructions if the data was nearly identical, but not exactly identical to the data or file fork in question.

Additionally, the present invention provides a method that is not in any way tied to the actual differencing method used to generate a “diff” from the file/data pairs which the method detects as the most likely matches.

The foregoing summary broadly sets out the more important features of the present invention so that the detailed description that follows may be better understood, and so that the present contributions to the art may be better appreciated. There are additional features of the invention that will be described in the detailed description of the preferred embodiments of the invention which will form the subject matter of the claims appended hereto.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

FIG. 1 is a schematic block diagram showing the method steps involved in the efficient near-duplicate data identification and ordering via attribute weighting and learning of the present invention.

### DETAILED DESCRIPTION OF THE INVENTION

The invention will be better understood and objects other than those set forth will become apparent when consideration is given to the following detailed description thereof. Such description makes reference to the annexed drawings.

Definitions: The following written description makes use of the following terms and phrases. As used herein the underlined terms have the indicated meaning.

Data set: a set of one or more typed files or data, also possessing attributes (including but not limited to directory, name, extension, type, creator, creation time, modification time, and access time.)

Archive: a collection of files created for the purpose of storage or transmission, usually in compressed and otherwise transformed form; an archive consists of structural information and archive data.

Attributes: parts of an archive that contain information about files/data, including, but not limited to type, pre- and post-archive transform sizes, extension, type, creator, creation time, modification time, and access time.

Fixed attributes: Some file attributes are fixed. That is, they are established when the file is created and cannot be changed (such as creation name, creator, file type)

Variable Attributes: The attributes of a file that can change each time a file is accessed or modified (such as size, name, modification date and hash values.)

Set of Attribute Weights: A table comprising and maintaining a list of each individual attribute with “weights” assigned to the attributes based on how accurate each attribute has been in determining approximate matches in the past—i.e. “type” by itself has a higher weight than “mod date.” Weights are initialized using some predefined values and updated over time during data processing.

Probable matches: Two or more files or data elements that are likely to be similar based on the weighted calculation for attributes done on them.

Delta encoding: a technique of storing data in the form of differences between sequential data rather than complete files.

Archive data: “data set” data in transformed form.

Archive creation: the process of combining multiple data sets and their attributes into an archive.

Archive expansion, full archive expansion: the process of recreating data sets, files, and their attributes from an archive.

Approximately duplicate files: two or more files having same set of attributes such as file size, type, creation date, creator, or calculated attributes.

Most likely duplicate files: When using the weighted attribute database in combination with the fixed and calculated attributes, “most likely duplicate files” are two or more files that appear to be most likely similar, and would thus benefit from a diffing process rather than stand-alone compression.

Archive transform, forward archive transform: transformation of data stored in an archive by application of algorithms including, but not limited to, compression, encryption, cryptographic signing, filtering, format detection, format-specific recompression, hash calculation, error protection and forward error correction.

Inverse archive transform: transformation of data that is the inverse of the forward archive transform, by application of algorithms including, but not limited to, decompression, decryption, verification of cryptographic signatures, inverse filtering, format-specific decompression, hash verification, error detection, and error correction.

Segment: part of a data set that is read in one operation.

When creating an archive from a set of files/data sets, a straightforward way to detect full or partial duplicates is to compare all incoming file forks, such as data forks and resource forks.

Efficient detection of exact or approximately duplicate data or files is achieved as follows:

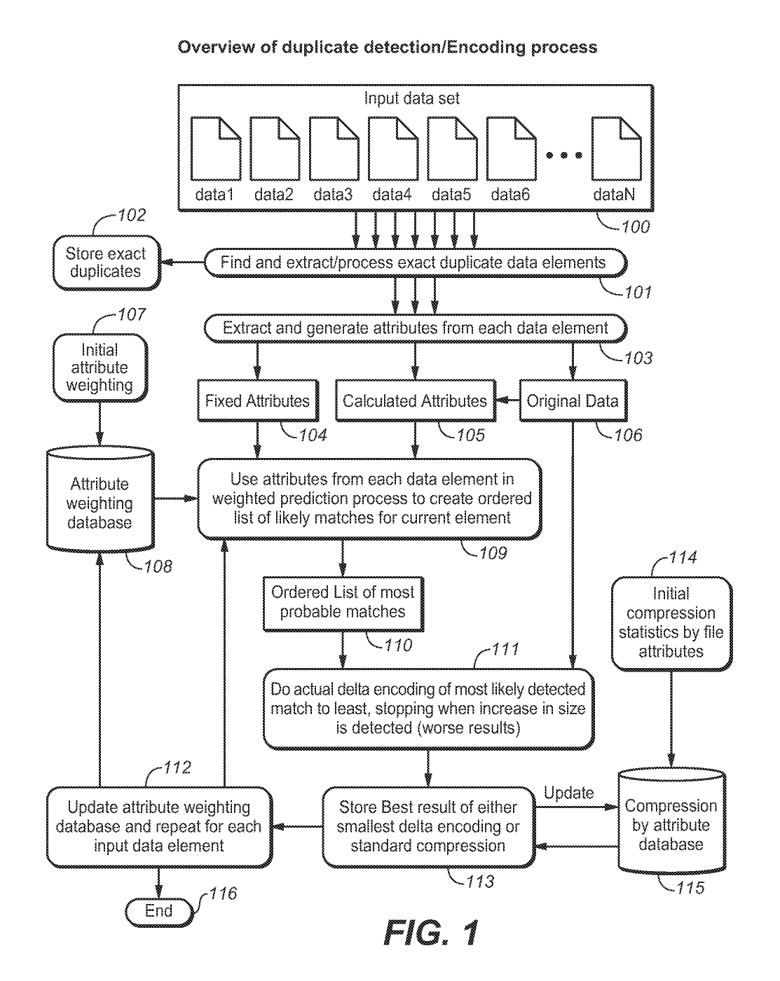

Referring to FIG. 1, there is illustrated therein a new and improved method for efficiently identifying and ordering near-duplicate data sets using attribute weighting and learning. The overall set of files/data sets to be compared for best possible matches is assembled into one set or several sets 100, using the compression technique described in the previously submitted and referenced invention, U.S. application Ser. No. 12/208,296, entitled, Efficient Full or Partial Duplicate Fork Detection and Archiving, noted above as incorporated in its entirety by reference herein, and which compression technique is graphically summarized in elements 100 and 101 of FIG. 1 herein.

Using an “Exact Encoding Technique” the exactly duplicate data elements are filtered out 101, and stored separately 102. These steps effectively remove all files which are exact duplicates of each other, leaving only those files that are potentially approximate duplicates to be further identified using this technique.

The remaining data set is passed to the algorithm to find most likely similar files. This starts with the attributes for each data element being extracted and generated 103.

The extracted attributes—Fixed attributes 104 and Calculated Attributes 105 are extracted for each data element. Original data elements are extracted 106 and passed to the Calculated Attributes extraction step 105.

Initial attributes are weighted and assigned an “Initial Attribute Weighting” 107 for storage in a “Set of Attribute Weights” 108, and after extraction the attributes from each data element are assigned a weight as per the values stored in the Set of Attribute Weights. Then the assigned weights for these attributes are used in the weighted prediction process to create an ordered list of most likely matches for the current element 109. Thus step 109 includes two inputs for each of one or more attributes: (1) the currently predicted match between a pair of files or other data—for example 0 to 100% likelihood of a match or other metric; and (2) how accurate that particular prediction has been in the past, i.e., a success rate for that attribute's prediction, possibly 0-100% accuracy or some other metric. These two metrics for each of the possible attributes are then merged into a single weighted “Result,” using a method taught in U.S. patent application Ser. No. 12/329,480, incorporated in its entirety by reference herein.

From the Weighted prediction process an ordered list of the most probable matches for the given data sets is prepared 110.

Based on the list of probable matches, delta encoding is performed on the set of files in the order of the files having higher to lower weighted prediction 111. The delta encoding is stopped when an increase in size is detected.

The data element is also compressed separately by standard compression techniques according to file attributes 114 and the result is stored in a “Compression by Attribute” database 115 which stores/learns the “Average” compression for a file with the given attributes.

The results from the delta compression and standard compression are compared and the best result for either the smallest delta encoding or standard compression is stored 113.

Based on the results from the comparison, the Set of Attribute Weights is updated 112 and the process for assigning a weight to each attribute is repeated for each input data element.

It should also be noted that file pairs that have been identified as pairs are also removed from future comparisons for the remaining data sets/files still to be compared.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

Therefore, the above description and illustrations should not be construed as limiting the scope of the invention, which is defined by the appended claims.

What is claimed as invention is:

1. A method of reducing redundancy and increasing processing throughput of an archiving process, comprising the steps of:
(a) providing an input data set having a plurality of data elements and/or files;
(a) detecting exact duplicate and approximately duplicate data elements or files that are either exactly similar or most likely similar; and
(b) storing references and/or differences to previously archived data;
wherein step (b) does not include the step of storing the duplicate or matched pairs of data using a standard compression technique.

2. The method of claim 1, wherein all exact duplicates are first detected and stored.

3. The method of claim 1, further including the step of extracting fixed attributes from the input data elements.

4. The method of claim 3, wherein the fixed attributes extracted from the input data may include, if available, at least file size, file type, file creation and modification dates, and other quickly stored or known attributes of the input file or data.

5. The method of claim 3, further including the step of assigning weight to different sets of data based on data set attributes.

6. The method of claim 5, where the weighting is updated, such that the weighting values adapts and changes over time to improve the predictive results.

7. The method of claim 3, wherein step (a) includes using a probability of a match based on a specific attribute (either fixed or calculated), and further including the step of associating a success rate with that specific attribute in the past.

8. The method of claim 1, further including the step of extracting calculated attributes from the input data elements.

9. The method of claim 8, wherein the calculated attributes extracted from the input data elements include at least byte and character distributions of the actual data, character/byte frequencies, and other transformations and calculation methods of partial or all portions of the files to be compared, partial CRC's, and compression of a subset of the files to be compared.

10. The method of claim 9, further including the step of assigning weight to different sets of data based on data set attributes.

11. The method of claim 10, wherein step (a) includes using a probability of a match based on a specific attribute (either fixed or calculated), and further including the step of associating a success rate with that specific attribute in the past.

12. The method of claim 11, wherein weighting is updated such that the weighting values adapt and change over time to improve the predictive results.

13. The method of claim 8, further including the step of assigning weight to different sets of data based on data set attributes.

14. The method of claim 13, wherein step (a) includes using a probability of a match based on a specific attribute (either fixed or calculated), and further including the step of associating a success rate with that specific attribute in the past.

15. A method for efficient full or partial duplicate data element detection and archiving, comprising the steps of:
detecting most likely similar data sets;
encoding the most likely similar data sets using delta encoding or using the most likely similar data sets to analyze different data sets.

16. A method for efficient full or partial duplicate data element detection and archiving, comprising the steps of:
(a) detecting most likely similar data sets;
(b) encoding the data sets using delta encoding;
(c) using a final weighting to predict the outcome of using a reference/differencing technique rather than a standard compression technique; and
(d) ordering of the data sets from the most likely file pairs to the least likely file pairs to benefit from using a differencing technique.

17. The method of claim 16, wherein further including the step of giving preference to those set of files that have been assigned a higher weight on the basis of their higher degree of likeness based on the attributes.

18. The method of claim 17, further including the steps of:
processing the pairs most likely to benefit from using a differencing technique;
comparing the results of using the differencing technique with the results of using a standard compression technique;
stopping the processing when an increase in file size is detected.

19. The method of claim 18, wherein the method that produces the smallest resulting archive file is used to store the result.

20. The method of claim 19, further including the step of maintaining a database of compression results are maintained, and updating the database over time, such that the likely result for using a standard compression technique can be calculated and used to determine the results the differencing technique must achieve for given file attributes to be worthwhile.

21. The method of claim 20, further including the step of storing the type of encoding used (whether differencing technique or standard compression technique) along with the data.

22. A method to extract data/files from an archive using a plurality of encoding methods including at least differencing, references, and standard compression techniques.

23. The method of claim 22, including the step of determining the optimal order and dependencies of the files to be extracted;
first extracting files and data that must be referenced by other data or files;
last extracting files and data that reference to other data or files.

24. A combination compression and differencing method for processing a given a set of data and/or files that include likely matches, which on the whole may result in a smaller overall result by using a combination of compression and differencing instead of individual compression, comprising the steps of:
(a) using a differencing algorithm to identify one or more of the data/files to be stored and/or compressed;
(b) storing and/or compressing the data/files identified in step (a);
(c) storing the remaining data/files as references to the stored and/or compressed file;
wherein the differencing algorithm employed in step (a) uses one or more of the following substeps:
(a.1) storing and/or compressing the largest file, earliest create date, or other metric, or some combination thereof, as a source file;
(a.2) storing and/or compressing each of the files differenced from the file stored as the source file;
(a.3) attempting to match each of the possible likely match combinations selected from a set of possible matches with each being used as the potential source file to determine the best overall result, the best overall combination, and producing the smallest overall size, of source and differences from that source are then stored and or transmitted.
